(19) United States
(12) Patent Application Publication
(10) Pub. No.: US 2015/0016352 A1
(43) Pub. Date: Jan. 15, 2015

(54) METHODS AND APPARATUS FOR PERFORMING RANDOM ACCESS CHANNEL PROCEDURES

(71) Applicant: QUALCOMM INCORPORATED, San Diego, CA (US)

(72) Inventors: Dominique Francois BRESSANELLI, Eschborn (DE); Won-Joon CHOI, San Diego, CA (US); Jong Hyeon PARK, San Jose, CA (US)

(21) Appl. No.: 14/324,604

(22) Filed: Jul. 7, 2014

Related U.S. Application Data
(60) Provisional application No. 61/844,805, filed on Jul. 10, 2013.

(51) Int. Cl. H04W 74/08

(52) U.S. Cl. CPC H04W 74/0833
USPC 370/329

(57) ABSTRACT

Certain aspects of the present disclosure generally relate to methods and apparatus for performing random access channel (RACH) procedures with a base station. For example, certain aspects provide methods and apparatus for performing RACH procedures when a user equipment moves out of range from the base station (e.g., for RACH procedure success). One method includes attempting a RACH procedure with a first base station, determining the UE is out of range from the first base station for RACH procedure success, and, upon determining the UE is out of range from the first base station for RACH procedure success, reattempting the RACH procedure with the first base station or a second base station.

### CLAIM OF PRIORITY UNDER 35 U.S.C. §119

The present Application for Patent claims priority to U.S. Provisional Application No. 61/844,805, entitled “METHODS AND APPARATUS FOR PERFORMING RANDOM ACCESS CHANNEL PROCEDURES”, filed on Jul. 10, 2013, and assigned to the assignee hereof and hereby expressly incorporated by reference herein.

### BACKGROUND

1. Field

Certain aspects of the present disclosure generally relate to methods and apparatus for performing random access channel (RACH) procedures with a base station, for example, when a user equipment (UE) moves out of range from the base station.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems, Long Term Evolution Advanced (LTE-A) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

### SUMMARY

In an aspect of the disclosure, a method for wireless communications by a user equipment (UE) is provided. The method generally includes attempting a random access channel (RACH) procedure with a first base station, determining the UE is out of range from the first base station for RACH procedure success, and upon determining the UE is out of range from the first base station for RACH procedure success, reattempting the RACH procedure with the first base station or a second base station.

In an aspect of the disclosure, an apparatus for wireless communications by a UE is provided. The apparatus generally includes means for attempting a random access channel (RACH) procedure with a first base station, means for determining the UE is out of range from the first base station for RACH procedure success, and upon determining the UE is out of range from the first base station for RACH procedure success, means for reattempting the RACH procedure with the first base station or a second base station.

In an aspect of the disclosure, a computer program product for wireless communications by a UE is provided. The computer program product generally includes a computer-readable medium comprising code for attempting a random access channel (RACH) procedure with a first base station, determining the UE is out of range from the first base station for RACH procedure success, and upon determining the UE is out of range from the first base station for RACH procedure success, reattempting the RACH procedure with the first base station or a second base station.

In an aspect of the disclosure, an apparatus for wireless communications by a UE is provided. The apparatus generally includes a processing system configured to attempt a random access channel (RACH) procedure with a first base station, determine the UE is out of range from the first base station for RACH procedure success, and upon determining the UE is out of range from the first base station for RACH procedure success, reattempt the RACH procedure with the first base station or a second base station.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 illustrates an example multiple access wireless communication system in accordance with certain aspects of the present disclosure.

FIG. 2 illustrates a block diagram of an access point and a user terminal in accordance with certain aspects of the present disclosure.

FIG. 3 illustrates various components that may be utilized in a wireless device in accordance with certain aspects of the present disclosure.

FIG. 4 illustrates a message flow for an LTE RACH contention-based procedure, in accordance with certain aspects of the present disclosure.

FIG. 5 illustrates examples for RACH preamble reception by an eNB, in accordance with certain aspects of the present disclosure.

FIG. 6 illustrates example operations for performing RACH procedures, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

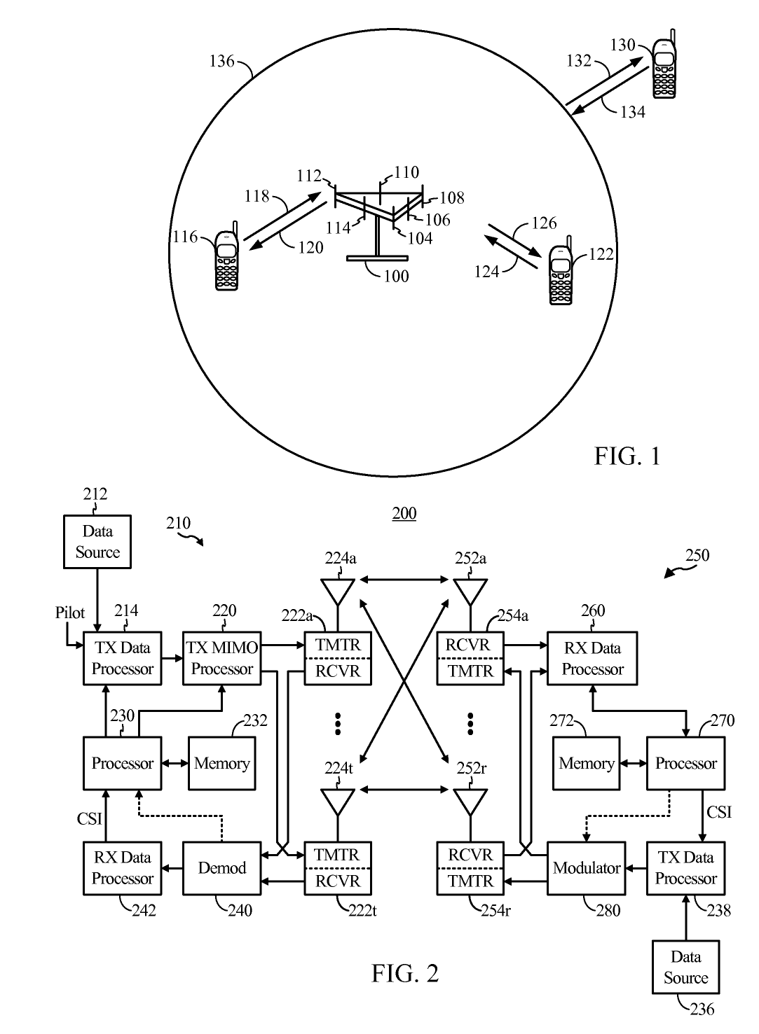

Referring to FIG. 1, a multiple access wireless communication system according to one aspect is illustrated. An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD (Frequency Division Duplex) system, communication links 118, 120, 124, and 126 may use different frequency for communication. For example, forward link 120 may use a different frequency than that used by reverse link 118.

Each group of antennas and/or the area in which they are designed to communicate is often referred to as a sector of the access point. In one aspect of the present disclosure, each antenna group may be designed to communicate to access terminals in a sector of the areas covered by access point 100.

Access terminal 130 may be in communication with access point 100, where antennas from the access point 100 transmit information to access terminal 130 over forward link 132 and receive information from the access terminal 130 over reverse link 134.

According to certain aspects, one of the access terminals (e.g., 116, 122, 130) may perform a random access channel (RACH) procedure, as described herein, to synchronize and gain access to the AP 100. A parameter “ZeroCorrelationZoneConfig” is generally configured by a network operator that defines a maximum cell size (e.g., cell edge 136) for RACH procedures. A RACH procedure will typically fail if the UE attempts it while positioned beyond this configured cell edge. In certain aspects, the parameter zeroCorrelationZoneConfig may restrict cell size for a RACH procedure to a lower value than the actual cell edge beyond which the UE may not communicate with the cell at all. It has been found that the UE may be camped on the LTE cell beyond the configured cell edge, but may not execute a RACH procedure successfully if it looses connection for some reason. As shown in FIG. 1, the UE 130 may communicate with AP 100 beyond the cell edge 136, but may not execute a RACH procedure successfully. Aspects of the present disclosure provide techniques for performing the RACH procedure successfully beyond the cell edge (e.g., cell edge 136) configured for RACH purposes, e.g., by the parameter ZeroCorrelationZoneConfig. In certain aspects, one or more of the access terminals 116, 122, and 130 may perform Random Access Channel (RACH) procedures in accordance with certain aspects of the present disclosure discussed below.

In communication over forward links 120 and 126, the transmitting antennas of access point 100 may utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

FIG. 2 illustrates a block diagram of an aspect of a transmitter system 210 (e.g., also known as the access point) and a receiver system 250 (e.g., also known as the access terminal) in a multiple-input multiple-output (MIMO) system 200. At the transmitter system 210, traffic data for a number of data streams is provided from a data source 212 to a transmit (TX) data processor 214.

In one aspect of the present disclosure, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230. Memory 232 may store data and software for the transmitter system 210.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion. Memory 272 may store data and software for the receiver system 250. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

Any one of the processor 270, RX data processor 260, and TX data processor 238, or a combination thereof of the access terminal 250 may be configured to perform the RACH procedures in accordance with certain aspects of the present disclosure discussed below. In an aspect, at least one of the processor 270, RX data processor 260, and TX data processor 238 may be configured to execute algorithms stored in memory 272 for performing the RACH procedures.

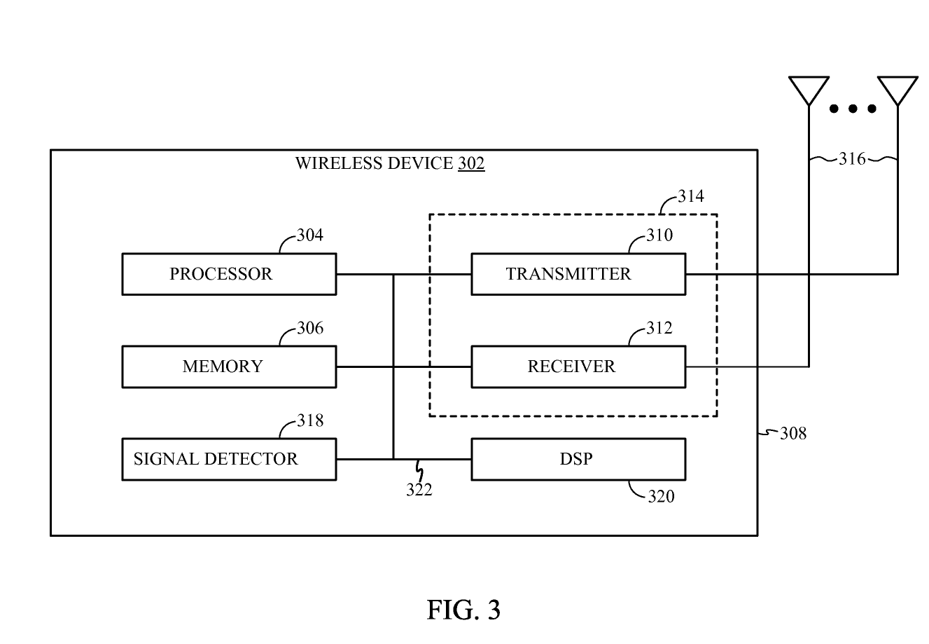

FIG. 3 illustrates various components that may be utilized in a wireless device 302 that may be employed within the wireless communication system illustrated in FIG. 1. The wireless device 302 is an example of a device that may be configured to implement the various methods described herein. The wireless device 302 may be a base station 100 or any of user terminals 116 and 122.

The wireless device 302 may include a processor 304 that controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus. The processor 304 may be configured to access instructions stored in the memory 306 to perform the RACH procedures in accordance with aspects of the present disclosure discussed below.

### Methods and Apparatus for Performing RACH Procedures

As discussed above, the parameter “ZeroCorrelationZoneConfig” is generally configured by a network operator to define a maximum cell size for RACH procedures. The “ZeroCorrelationZoneConfig” parameter may typically be read by the UE from a system information block (SIB) 2 message broadcast by the cell. It has been found that a UE may be camped on a suitable LTE cell beyond the distance (e.g., cell size) that is expected by an operator when the system information block (SIB) 2 parameter, “zeroCorrelationZoneConfig”, is initially configured. In practice, this may lead to failure of a random access channel (RACH) procedure because a base station (e.g., an evolved Node B (eNB) in the LTE cell) may translate RACH preamble information received from the UE into another cyclic shift of the same Zadoff-Chu sequence. This may result in a loss of service from the user point of view and a wasted use of battery (e.g., due to repeated attempts of the RACH procedure). Certain aspects of the present disclosure provide techniques for a UE to detect the “out of cell coverage” state described above, and ensure a successful RACH procedure.

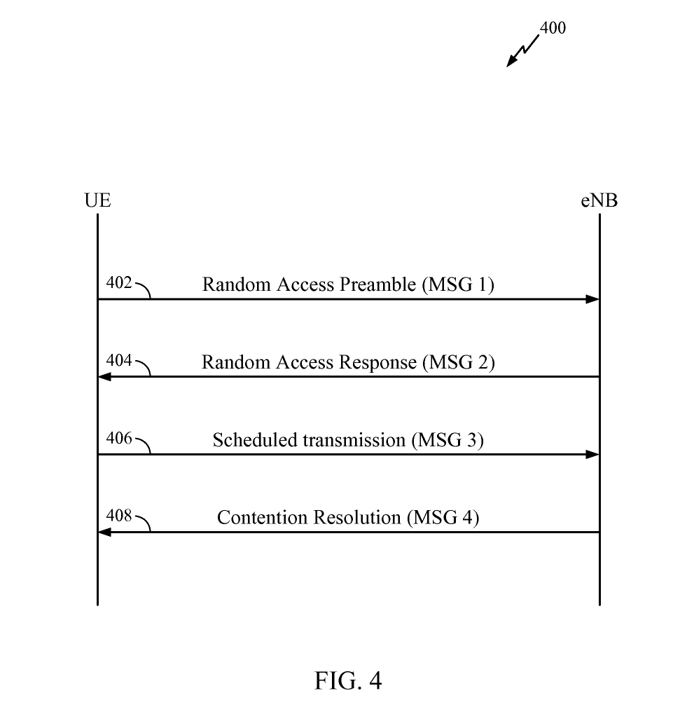

FIG. 4 illustrates a message flow 400 for an example LTE RACH contention-based procedure, in accordance with certain aspects of the present disclosure. At 402, a UE may send a preamble (MSG 1), assuming an initial Timing Advance of zero for FDD. Typically, a preamble is randomly chosen by the UE among a set of preambles allocated on the cell and may be linked to a requested size for MSG 3 (discussed below). At 404, an eNB may send a random access response (RAR). A random access preamble identifier (RAPID) field in MSG 2, a field of the medium access control (MAC) header for the RAR, may be equal to the decoded preamble ID from MSG 1 and may enable the UE to match the RAR with the initial request. MSG 2 may also indicate a grant for MSG 3. At 406, the UE may send MSG 3 using the grant. At 408, the eNB may decode MSG 3 and either echo back the RRC (Radio Resource Control) signaling message or send an UL grant (e.g., DCI 0) scrambled with a cell radio network temporary identifier (C-RNTI).

In certain aspects, an operator may configure a maximum cell size for RACH procedures. A signaling parameter for determining the cell size may include the ZeroCorrelationZoneConfig parameter from SIB 2 discussed above. The maximum cell size may depend on the following parameters shown in table below:

| | |
|---|---|
| N_{CS} | may be directly mapped from |
| | ZeroCorrelationZoneConfig (e.g., |
| | using 3GPP TS36.211, Table 5.7.2-2) |
| T_{SEQ} | may be the physical RACH (PRACH) |
| | sequence length in microseconds (e.g., |
| | T_{SEQ} = 800 for preamble format 0 to 3) |
| N_{ZC} | may be the random access preamble |
| | sequence length (e.g., N_{ZC} = 839 for |
| | preamble format 0 to 3) |
| Max-delay spread | e.g., in microseconds |
| N_{g} | may be the number of additional guard |
| | samples due to receiver pulse shaping |
| | filter |

The maximum cell radius (max-cell-radius e.g., in kilometers) may be determined based on the above defined parameters as 3/20*((N_{CS}−N_{g})*(T_{SEQ}/N_{ZC})−max-delay spread.

In certain aspects, although a contention-based RACH procedure is described above, the present methods and apparatus may be employed for other types of RACH procedures.

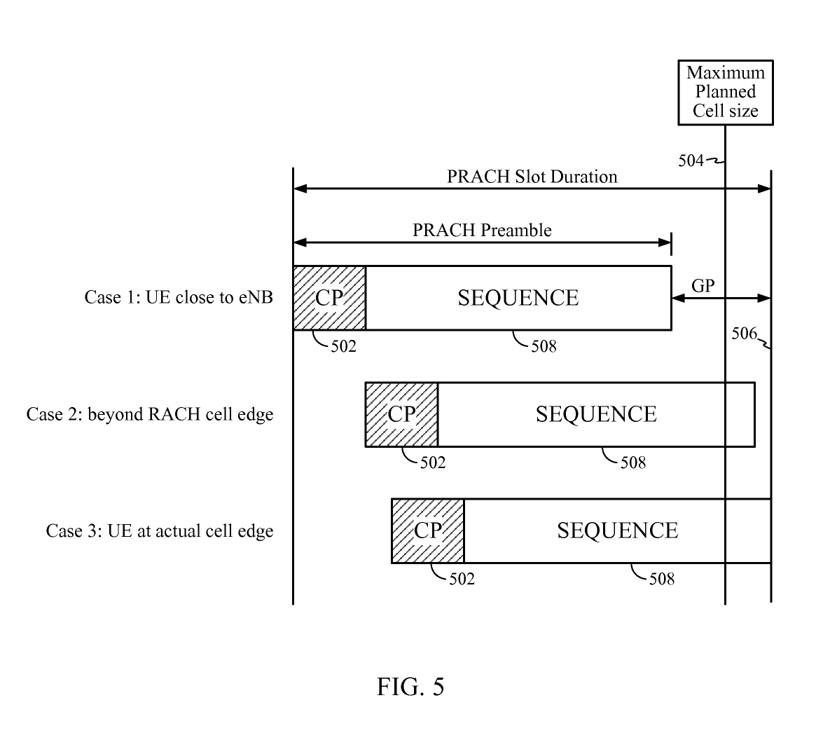

FIG. 5 illustrates examples for RACH preamble reception by an eNB, in accordance with certain aspects of the present disclosure. In certain aspects, the UE may be in close proximity to the eNB (e.g., within the cell size of the eNB; Case 1). In this case, the cyclic prefix (CP) 502 of the PRACH preamble may be aligned with PRACH subframe start, as illustrated.

In certain aspects, the UE may be beyond a maximum planned cell edge 504 for RACH coverage (Case 2), as defined by the parameter ZeroCorrelationZoneConfig. For example, this may occur when the UE is located beyond the distance from the eNB as determined by the above-described max-cell radius. In an aspect, one of the properties of Zadoff-Chu sequences typically used for the preamble is that as long as cyclic shift is different from zero, the eNB may detect a sequence ID which is preamble ID from the UE minus n, where n is a small integer (e.g., 1). In certain aspects of the present disclosure, this property may be used to detect the fact that UE may have moved out of the cell range (e.g., planned cell range), and also to advance UE timing so as to ensure that the RACH procedure is successful. In certain aspects, prior to advancing the UE timing, the UE may search for another eNB for initiating the RACH procedure (e.g., camp on another serving eNB) instead of advancing the UE timing.

In certain aspects, a parameter (e.g., ZeroCorrelationZoneConfig) may restrict cell size for a RACH procedure to a lower value 504 than the actual cell edge 506, which may be defined by the point where the end of the preamble sequence 508 is aligned with the end of a guard period (GP) (Case 3). The line 504 indicates the cell edge for RACH as may be defined by ZeroCorrelationZoneConfig. As illustrated in FIG. 5, the preamble sequence 508 in Case 2 is beyond the cell edge, as far as RACH planned coverage is concerned. Therefore, the eNB may detect a sequence ID which is preamble ID from the UE minus 1. The case of the UE beyond planned cell edge for a RACH procedure is further described below.

As described above, the eNB may translate a RACH preamble information received from the UE into another cyclic shift of the same Zadoff-Chu sequence. The eNB may believe that it receives a preamble whose cyclic shift value is ZeroCorrelationZoneConfig lower than the one submitted by the UE because the computed timing advance would fall within the expected range. From the UE point of view, the RAPID received in MSG 2 may be equal to the preamble ID minus 1 and, therefore, may not match to the preamble ID sent in MSG 1. As a result, the UE may ignore the MSG 2. As a result of ignoring the MSG 2, the UE may be stuck a long time on a cell without any service.

Unlike other standards, such as GSM, LTE has no mechanism to force cell reselection in case of repeated RACH procedure failures. Another negative impact may include interference created on uplink RACH for no purpose, and downlink resources (e.g., physical downlink control channel (PDCCH) and physical downlink shared channel (PDSCH) scrambled with a random access RNTI (RA-RNTI)) are wasted.

In certain aspects, communication between the UE and the eNB may be possible beyond RACH range, and may continue until a RACH procedure is needed. For example, a UE may be served by a cell until connection release is triggered by the eNB due to user inactivity. At RRC connection release time, the latest signaled timing advance may be beyond the RACH cell size as configured by ZeroCorrelationZoneConfig without causing any noticeable issue. However, the UE may be unable to establish a new RRC connection on the same cell a few seconds later as RACH procedure would systematically fail.

3GPP TS36.211 mandates that the start of the random access preamble formats 0-3 should be aligned with the start of the corresponding uplink subframe at the UE and that UE should assume a timing advance (TA) of zero when submitting the RACH preamble. Certain aspects of the present disclosure involve deviating from the latter requirement (initial TA=0) in case the UE detects that it may be beyond the distance allowed by ZeroCorrelationZoneConfig, as described above.

In certain aspects, when the UE is beyond the distance allowed by ZeroCorrelationZoneConfig, the RACH procedure may fail as the UE may receive the RAPID from the RAR (e.g., MSG 2) that equals preamble ID from MSG 1 minus 1 (or an integer n). However, there is a possibility that the RAPID may be aimed at another UE which genuinely sent MSG 1 preamble ID equal to MSG 1 preamble ID of the UE under test minus 1 at similar time. In certain aspects, to account for this possibility, the UE may consider that “beyond cell range location” state has been detected only after x among y consecutive RACH failure attempts where UE receives RAPID equal to preamble ID minus 1.

In certain aspects, after detecting that the UE is in a “beyond cell range location” state, the UE may advance the next MSG 1 timing (e.g., for another RACH attempt) by “timing advance corresponding to cell size” and possibly also a delta. In other words, the UE may apply a non-zero initial TA for the MSG 1 transmission. Then upon reception of MSG 2 with a matching RAPID, the UE may consider that the current TA is equal to the signaled TA in MSG 2 plus the TA used in MSG 1, and as a result, call establishment may proceed. The “timing advance corresponding to cell size” may be defined as the number of TA units (e.g., 1 TA=16*Ts) corresponding to the cell size. It may be demonstrated that:

timing advance corresponding to cell size=floor(N_{CS}*(1536/839))−delta

In certain aspects, the delta may be used to reduce the effective cell size to take into account delay spread and/or one or more guard samples due to receiver pulse shaping filter on eNB side. A typical value for delta may be 3 or 5, although other values may be employed.

The following example algorithm represents example aspects of the present disclosure. In certain aspects, this algorithm may be implemented by a UE or any entity controlling the operation of the UE. In certain aspects, this algorithm may be stored in a processor readable memory (e.g., 272, 306) and accessed and executed by a processor (e.g., 260, 270, 238, 304) to control operations of the UE. In this example, the algorithm compares the RAPID fields in MSG 2 with the preambles sent in MSG 1 in order to determine whether the UE is out of range from a serving base station for initiating a RACH procedure. The algorithm attempts a RACH procedure with the serving base station a consecutive number of times and determines that the UE is out of range from the serving base station if the RACH procedure attempts with the serving base station fails a predetermined number of times of the consecutive number of times. If the UE is out of range from the serving base station, the system attempts the RACH procedure with the serving base station with a non-zero TA. Further, upon failure of a predetermined configurable number of RACH procedure attempts with a non-zero TA, the cell is barred for a short time to prevent battery drain and/or cell reselection is attempted.

The example algorithm for performing a RACH procedure in accordance with aspects discussed above may include the UE initially assuming that it is not beyond cell range (e.g., as set by the parameter ZeroCorrelationZoneConfig) for RACH procedure purposes by setting a parameter “Beyond_cell_range” to “False”. A parameter “M0” may define a number of last few attempts with cyclic shift (of preamble sequence) different from zero that will be stored. For example, M0 may be set to four, thus limiting the number of attempts with non-zero cyclic shift to be stored, to last four attempts. A parameter “last_M0_preamble” may be defined to store the last M0 attempts, and initialized to e.g., [False, False, False, False], the length of this set being equal to M0 and each entry indicating whether the UE is beyond cell range or not. A “False” indicates that the UE is not beyond cell range and a “True” indicates that the UE is beyond cell range. The UE may start the RACH procedure by transmitting Msg 1 with a randomly chosen preamble (e.g., chosen previously and sent by a base station) with non zero cyclic shift and zero TA. Upon receiving a RAPID (e.g., as part of Msg 2) which matches the preamble id of Msg 1, the UE may set the last entry of last_M0_preamble to False. On the other hand, if the UE receives a RAPID that does not match the preamble id of Msg1 indicating that the UE may be beyond cell range, it may set the last entry to True. In an aspect, the UE may re-attempt sending Msg1 and recording in the last_M0_preamble until it receives a RAPID that equals the transmitted preamble id, or a maximum number of re-attempts is made. For example, a predetermined number of maximum re-attempts may be set and a counter may be used to keep track of the number of attempts. In an aspect, upon the UE receiving non matching RAPIDs in the last N0 attempts and when the last N0 entries of the parameter last_M0_preamble is set to True, the UE may determine that it is beyond cell range of RACH procedure purposes and may set beyond_cell_range parameter to True. In an aspect, N0<=M0. For example, N0 may be set to 3 when M0 is set to 4.

After setting Beyond_cell_range to True, the UE may start transmitting Msg1 with a modified non-zero TA. As discussed above, the non-zero TA may be determined by (floor(N_{CS}*(1536/839))−delta). If the UE receives Msg2 with matching preamble id indicating a successful attempt, the UE may set its TA to TA applied to Msg1 plus TA received in Msg2 RAR. The UE may then use this TA for Msg3 and also as a base for further timing computation based on received MAC TA commands. On the other hand, if the UE receives a non matching Msg 2 even with the modified TA, it may re-attempt the RACH procedure with the modified TA, for example, until it receives a matching Msg2 or until a predetermined number of maximum re-attempts with the modified TA has been made. In an aspect, a predetermined number of maximum re-attempts (K0) may be set and a counter may be used to keep track of the number of re-attempts. For example, K0 for this example may be set to three.

In certain aspects, if the UE fails to receive a matching Msg2 after the maximum set number of re-attempts with the modified TA, it may bar the cell for a short time to prevent battery drain and/or attempt cell reselection. The UE may additionally reset the parameter Beyond_cell_range to False, for example, for use in another iteration of the above discussed algorithm.

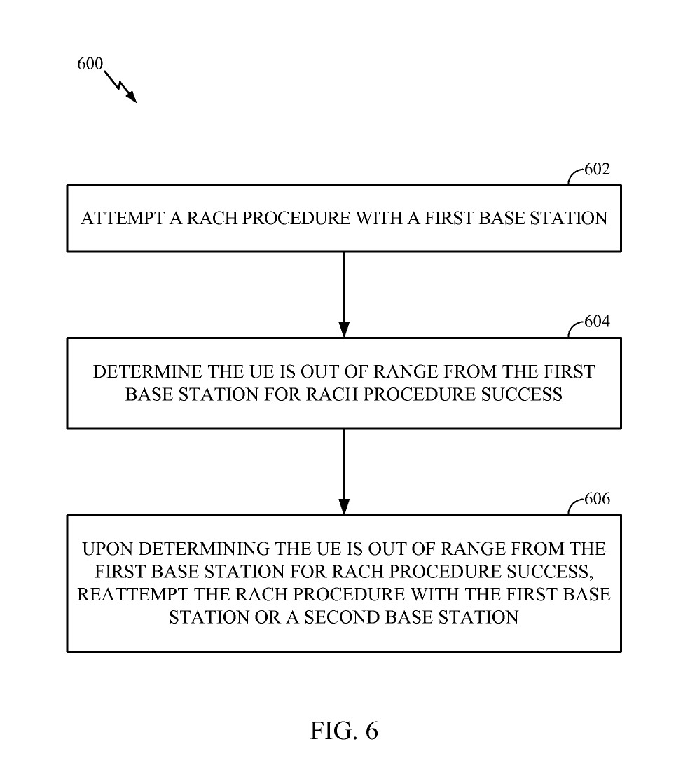

FIG. 6 illustrates example operations 600 for performing RACH procedures, in accordance with certain aspects of the present disclosure. The operations 600 may be performed, for example, by a UE. At 602, the UE may attempt a RACH procedure with a first base station. In certain aspects, the UE may attempt the RACH procedure with the first base station with a zero timing advance (TA). In other words, the UE may apply no TA for a RACH preamble transmission from the UE.

At 604, the UE may determine that the UE is out of range from the first base station for RACH procedure success. In certain aspects, the UE may make this determination by attempting the RACH procedure with the first base station a consecutive number of times, and determining the RACH procedure with the first base station has failed a predetermined number of times of the consecutive number of times. The UE may determine the RACH procedure with the first base station has failed by receiving a random access preamble identifier (RAPID) associated with a random access response (RAR) that is different from a RACH preamble transmitted from the UE. In an aspect, the RAPID is the RACH preamble minus n, where n is a small integer that is constant across consecutive RACH attempts. In certain aspects, the UE may determine that it is out of range from the first base station for RACH procedure success by determining the UE is beyond a distance from the first base station as defined by a ZeroCorrelationZoneConfig parameter broadcast in a SIB. In an aspect, the distance between the UE and the first base station may be estimated from a difference between the RACH preamble and the RAPID.

At 606, upon the UE determining that it is out of range from the first base station for RACH procedure success, the UE may reattempt the RACH procedure with the first base station or a second base station. For example, the UE may reattempt the RACH procedure with the first base station, but this time using a non-zero TA. In certain aspects, the UE may search for the second base station and if the search for the second base station fails, the UE may attempt the RACH procedure with the first base station with a non-zero timing advance (TA).

In certain aspects, the UE may reattempt the RACH procedure with the first base station with the non-zero TA by applying the non-zero TA for a RACH preamble transmission from the UE. In certain aspects, the UE may apply the non-zero TA for a Msg 3 transmission from the UE. In certain aspects, the UE may apply a non-zero TA for the Msg 3, which is a sum of the non-zero TA (e.g., applied to RACH preamble) and a TA received in a random access response (RAR).

In certain aspects, reattempting the RACH procedure with the first base station includes the UE attempting the RACH procedure with the first base station with a TA corresponding to at least a distance from the first base station and a delta. In an aspect, the TA may include a number of TA units corresponding to the distance from the first base station. In an aspect, the delta accounts for one or more of a delay spread and an additional guard sample due to a receiver pulse shaping filter at the first base station.

In certain aspects, the UE may determine that it is not out of range from the first base station for RACH procedure success after a number of RACH procedure reattempt failures with the first base station. Consequently, the UE may stop the RACH procedure reattempts with the first base station.

In certain aspects, upon failure of a predetermined configurable number of RACH procedure re-attempts with the first base station with the non-zero TA, the UE may bar the first base station for at least a period of time to prevent battery drain, and/or attempt reselection of a cell.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communications by a user equipment (UE), comprising:
attempting a random access channel (RACH) procedure with a first base station;
determining the UE is out of range from the first base station for RACH procedure success; and
upon determining the UE is out of range from the first base station for RACH procedure success, reattempting the RACH procedure with the first base station or a second base station.

2. The method of claim 1, wherein:
the attempting comprises attempting the RACH procedure with the first base station with a zero timing advance (TA); and
the reattempting comprises attempting the RACH procedure with the first base station with a first non-zero TA.

3. The method of claim 2, wherein the attempting the RACH procedure with the first base station with the first non-zero TA comprises applying the first non-zero TA for a RACH preamble transmission from the UE.

4. The method of claim 2, wherein the attempting the RACH procedure with the first base station with the first non-zero TA further comprises applying the first non-zero TA for a Msg 3 transmission from the UE.

5. The method of claim 4, wherein the applying the first non-zero TA for the Msg 3 transmission comprises applying a second non-zero TA for the Msg 3 transmission, which is a sum of the first non-zero TA and a TA received in a random access response (RAR).

6. The method of claim 2, further comprising determining the UE is not out of range from the first base station for RACH procedure success after a number of RACH procedure reattempt failures with the first base station.

7. The method of claim 6, further comprising stopping the RACH procedure reattempts with the first base station.

8. The method of claim 1, wherein the reattempting comprises searching for the second base station.

9. The method of claim 8, further comprising:
determining the search for the second base station has failed; and
upon the determination, attempting the RACH procedure with the first base station with a non-zero timing advance (TA).

10. The method of claim 1, wherein the determining comprises:
attempting the RACH procedure with the first base station a consecutive number of times; and
determining the RACH procedure with the first base station has failed a predetermined number of times of the consecutive number of times.

11. The method of claim 10, wherein the determining the RACH procedure with the first base station has failed comprises receiving a random access preamble identifier (RAPID) associated with a random access response (RAR) that is different from a RACH preamble transmitted from the UE.

12. The method of claim 11, wherein the RAPID is the RACH preamble minus n, where n is a small integer which is constant across consecutive RACH attempts.

13. The method of claim 11, wherein the determining the UE is out of range from the first base station for RACH procedure success comprises determining the UE is beyond a distance from the first base station that is based on a ZeroCorrelationZoneConfig parameter broadcast in a system information block (SIB).

14. The method of claim 13, wherein a distance between the UE and the first base station is estimated from a difference between the RACH preamble and the RAPID.

15. The method of claim 1, wherein the reattempting comprises attempting the RACH procedure with the first base station with a timing advance (TA) corresponding to at least a distance from the first base station and a delta.

16. The method of claim 15, wherein the TA corresponding to at least the distance from the first base station comprises a number of TA units corresponding to the distance from the first base station.

17. The method of claim 15, wherein the delta accounts for one or more of a delay spread and an additional guard sample due to a receiver pulse shaping filter at the first base station.

18. The method of claim 1, wherein the reattempting comprises reattempting the RACH procedure with the first base station with a non-zero TA for at least a predetermined configurable number of reattempts,
further comprising:
upon failure of the predetermined configurable number of reattempts, performing at least one of:
barring the first base station for at least a period of time to prevent battery drain, or
attempting reselection of a cell.

19. A computer program product for wireless communications by a user equipment (UE), comprising:
a computer-readable medium comprising code for:
attempting a random access channel (RACH) procedure with a first base station;
determining the UE is out of range from the first base station for RACH procedure success; and
upon determining the UE is out of range from the first base station for RACH procedure success, reattempting the RACH procedure with the first base station or a second base station.

20. An apparatus for wireless communications by a user equipment (UE), comprising:
a processing system configured to:
attempt a random access channel (RACH) procedure with a first base station;
determine the UE is out of range from the first base station for RACH procedure success; and
upon determining the UE is out of range from the first base station for RACH procedure success, reattempt the RACH procedure with the first base station or a second base station.
